(19) United States
(12) Patent Application Publication
(10) Pub. No.: US 2008/0226033 A1
(43) Pub. Date: Sep. 18, 2008

(54) X-RAY APPARATUS WITH AN X-RAY MODULE HAVING INDIVIDUALLY CONTROLLABLE X-RAY SOURCES

(76) Inventors: Peter Schardt, Hochstadt A.D. Aisch (DE); Frank Sprenger, Cary, NC (US)

Correspondence Address: SCHIFF HARDIN, LLP;PATENT DEPARTMENT, 6600 SEARS TOWER, CHICAGO, IL, 60606-6473, US

(21) Appl. No.: 12/048,378

(22) Filed: Mar. 14, 2008

(30) Foreign Application Priority Data
Mar. 14, 2007 (DE) 10 2007 012 362.2

(51) Int. Cl. H01J 35/06

(52) U.S. Cl. 378/134

(57) ABSTRACT

An x-ray apparatus has at least one radiator module with a sealed vacuum housing and a high voltage connection. The at least one radiator module extends only partially around an examination space and has at least two x-ray sources that can be controlled individually.

### BACKGROUND OF THE INVENTION

1. Field of the Invention

The invention concerns an x-ray apparatus.

2. Description of the Prior Art

The computed tomography apparatus known from DE 103 46 682 B4 represents an example of an x-ray apparatus of the type having a stationary part in which a gantry is mounted such that it can rotate. An x-ray radiator (rotary anode tube or rotary anode radiator) and an x-ray detector opposite thereto are arranged within the gantry. Furthermore, a portion of the necessary peripheral apparatuses and aggregates is arranged in the gantry. This complex structure results in a heavy weight of the gantry. During the operation of the computed tomography apparatus the x-ray radiator and the x-ray detector are moved in the circumferential direction around an examination space by the gantry driven by an electrical drive. X-ray exposures of an region of interest of an examination subject situated in the examination region are produced in a known manner at up to three rotations per second. The diagnostic data are reconstructed with a high image quality by suitable algorithms from the x-ray radiation detected by the x-ray detector and attenuated after passage through the examination subject.

In all known computed tomography systems, the mechanical design (including the signal and energy transfer to and from the rotating gantry) represents a significant portion of the total cost of the system due to the technical complexity thereof.

### SUMMARY OF THE INVENTION

An object of the present invention is to provide an x-ray apparatus that is designed more simply in terms of structure.

The above object is achieved in accordance with the invention by an x-ray apparatus having at least one radiator module with a sealed vacuum and a high voltage connection, the at least one radiator module extending only partially around an examination space, and having at least two x-ray sources that can be controlled (activated) individually. The x-ray sources preferably are formed by a fixed (stationary) anode.

Because the radiator module extends only partially around the examination space and has at least two individually controllable x-ray sources, the x-ray sources need execute no rotation movements for x-ray acquisitions. The high design cost that is necessary in the x-ray apparatus according to DE 103 46 682 B4 due to the gantry rotating around the examination space is therewith not required in the inventive x-ray apparatus. A corresponding cost savings results from the reduced design expenditure.

In the inventive x-ray apparatus the number of the stationary radiator modules as well as the number of the x-ray sources arranged therein can be designed in a simple manner corresponding to individual apparatus requirements. The x-ray apparatus according to the invention is thus suitable both for medical diagnostics for people and animals and for the non-destructive examination of different materials (for example, luggage).

In the x-ray apparatus according to the invention, the movement of the x-ray source that was previously required around the examination space is replaced by a mechanically unproblematical (in contrast to a rotation movement) individual activation of the x-ray sources. The x-ray sources thus can be individually activated and deactivated in chronological succession. A simultaneous activation and deactivation of a number of the x-ray sources is also possible in the inventive solution.

The inventive x-ray apparatus offers further significant advantages in addition to a low-cost mechanism due to the omission of rotating x-ray sources. For example, arbitrary geometries can be realized via the modular design. The radiator module can be fashioned, for example, as a curved radiator module, in particular as a radiator module shaped like a circular arc. An embodiment as a straight radiator module can also be realized in the framework of the invention.

Since each radiator module has its own high voltage connection, the individual radiator modules can be operated with different voltages.

The inventive x-ray apparatus also offers significant advantages from production points of view. The radiator modules can be individually produced corresponding to the respective requirement profile (for example design with regard to the image reconstruction problem) and be correspondingly tested.

The maintenance and repair cost is also correspondingly low in the inventive x-ray apparatus due to the modular design. A radiator module that is defective or has decreased in its intensity can be replaced quickly and with little effort by a user (thus on site).

According to a preferred embodiment of the inventive x-ray apparatus, a number of radiator modules extend in total completely around the examination space, so x-ray exposures can be made that exhibit the same quality as x-ray exposures that were acquired with a computed tomography apparatus that is comparable in terms of its radiation source.

### BRIEF DESCRIPTION OF THE DRAWINGS

FIG. 1 shows an embodiment of an inventive x-ray apparatus in a schematic section view.

FIG. 2 illustrates the replacement of a missing projection by a suitable back-projection in the operation of the apparatus of FIG. 1.

FIGS. 3 through 5 respectively show different embodiments of radiator modules in accordance with the invention.

### DESCRIPTION OF THE PREFERRED EMBODIMENTS

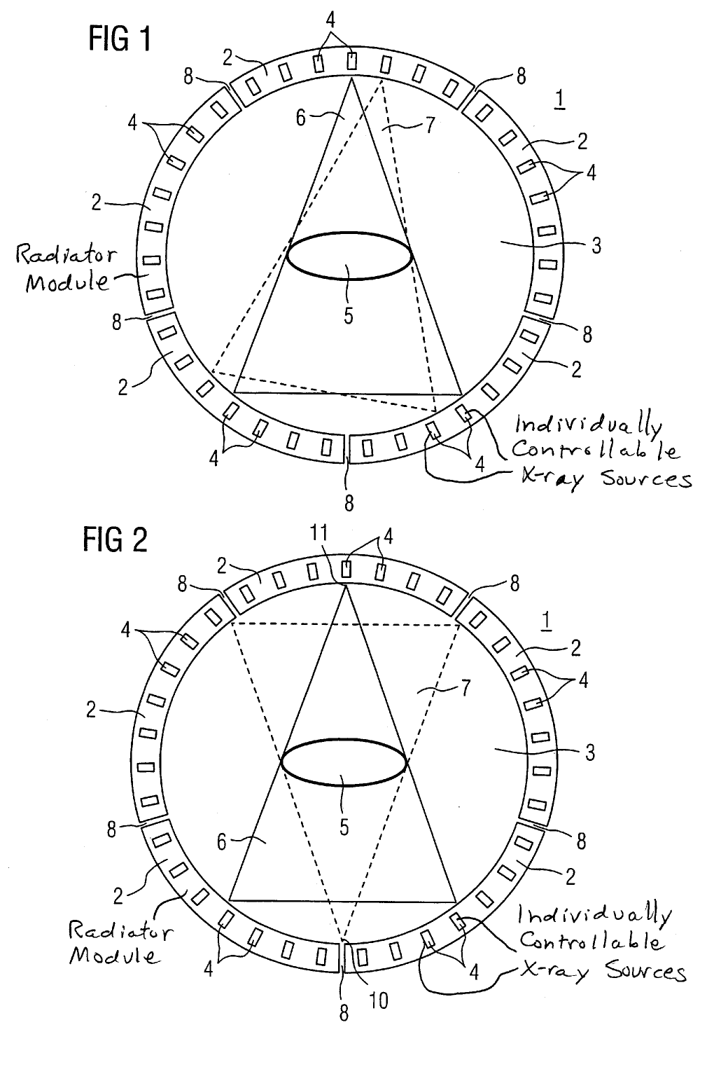

In the exemplary embodiment shown in FIGS. 1 and 2, an x-ray apparatus is designated with 1, and has five identically fashioned radiator modules 2 that, in total, extend completely around an examination space 3. Each radiator module 2 extends around only a portion of the examination space 3. The radiator modules 2 are executed as circular arc-shaped radiator modules, such that the examination space 3 is circularly surrounded by the radiator modules 2.

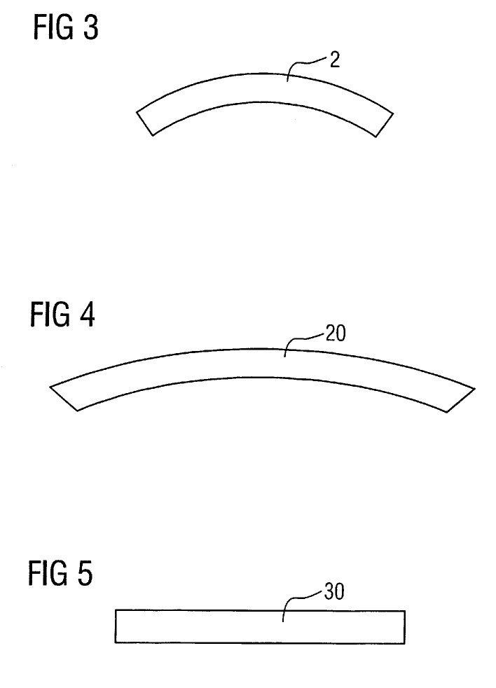

Instead of circular arc-shaped radiator modules 2 (see FIGS. 1 through 3), the x-ray apparatus 1 can be curved radiator modules 20 with arbitrary curvature radii (see FIG. 4) or straight radiator modules 30 (see FIG. 5). The arrangement of differently fashioned radiator modules is also possible in the inventive x-ray apparatus 1. The examination space 3 can be surrounded in a different shape than a circle (for example octagonally, elliptically).

In accordance with the invention, each radiator module 2 has at least two individually controllable x-ray sources 4. In the embodiment of the inventive x-ray apparatus 1 shown in FIG. 1 seven x-ray sources 4 are respectively arranged in each radiator module 2.

In the framework of the invention more or fewer than five radiator modules 2 can be arranged around the examination space 2, dependent on the application case. The radiator modules 2 also do not necessarily have to be executed identically. Furthermore, the radiator modules 2 can be arranged so as to extend in total only partially around the examination space 3.

Each radiator module 2 has a sealed vacuum housing and a high voltage connection (not shown).

An examination subject 5 is located in the examination space 2 for the duration of the examination. This subject 5 can be, for example, a patient or an item of luggage.

As can be seen from FIG. 1, in the x-ray apparatus 1 the movement of an x-ray source around the examination space 3 that was previously required is replaced by a mechanically unproblematical individual activation of the stationary x-ray sources 4. The x-ray sources 4 can thus be individually activated and deactivated in chronological succession. A simultaneous activation and deactivation of multiple x-ray sources 4 is also possible in the inventive solution.

The individual control of the x-ray sources 4 and the angle-dependent changes of the x-rays 6 and 7 penetrating the examination subject 5 that are connected with this are respectively symbolized by a triangle with a solid line and by a triangle with a dashed line in FIGS. 1 and 2.

The possible replacement of a missing projection 10 via a suitable back-projection 11 in the x-ray apparatus according to FIG. 1 is shown in FIG. 2. Missing projections occur at the joint (boundary) locations 8 of two adjacent radiator modules 2.

In this example the missing projection 10 is replaced by a projection 11 offset by 180° (back projection). This projection 11 from the opposite direction replaces the projection 10 missing due to the joint location. This reconstruction of the missing projection 10 is possible in the shown x-ray apparatus 1 since an odd number of radiator modules 2 is arranged around the examination space 3 and opposite joint locations 8 (joint locations 8 offset by precisely 180°) are thereby avoided.

Although modifications and changes may be suggested by those skilled in the art, it is the intention of the inventors to embody within the patent warranted hereon all changes and modifications as reasonably and properly come within the scope of their contribution to the art.

We claim as our invention:

1. An x-ray apparatus comprising:
at least one radiator module comprising a sealed vacuum housing and a high voltage connection, said at least one radiator module extending only around a portion of an examination space to be irradiated with x-rays; and
said at least one radiator module comprising at least two x-ray sources that are individually controllable to emit said x-rays.

2. An x-ray apparatus as claimed in claim 1 comprising a plurality of radiator modules that, in total, extend completely around said examination space.

3. An x-ray apparatus as claimed in claim 1 comprising a plurality of radiator modules that, in total, extend only partially around said examination space.

4. An x-ray apparatus as claimed in claim 1 wherein each of said radiator modules has a shape forming a circular arc.

5. An x-ray apparatus as claimed in claim 1 comprising an odd number of radiator modules extending around said examination space.

6. An x-ray apparatus as claimed in claim 1 comprising a plurality of identical radiation modules.

7. An x-ray apparatus as claimed in claim 1 wherein said at least one radiator module has a shape formed by a non-circular curve.

8. An x-ray apparatus as claimed in claim 1 wherein said at least one radiator module is straight.

9. An x-ray apparatus comprising:
a radiator module comprising a field vacuum housing and a high-voltage connection and extending completely around an examination space to be irradiated with x-rays; and
said radiator module comprising at least two x-ray sources that are individually controllable.
